(19) United States
(12) Patent Application Publication
(10) Pub. No.: US 2006/0129964 A1
(43) Pub. Date: Jun. 15, 2006

(54) Net list generating method and layout designing method of semiconductor integrated circuit

(75) Inventors: Harumi Shibasaki, Tama-shi (JP); Tarou Fukunaga, Sagamihara-shi (JP); Maya Ishino, Sagamihara-shi (JP); Kouhei Nakai, Sagamihara-shi (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/297,389

(22) Filed: Dec. 9, 2005

(30) Foreign Application Priority Data
Dec. 10, 2004 (JP) P2004-358001

(51) Int. Cl. G06F 17/50; G06F 9/45

(52) U.S. Cl. 716/12; 716/9

(57) ABSTRACT

A placement 103 of a macrocell is applied to a net list 102 formed by the logic synthesis by using the automatic layout tool, physical information of the macrocell is extracted in a physical information extracting step 104, and a net list 106 including the physical information is generated by attaching the extracted physical information to the instance name of the macrocell. Since the physical information such as placement coordinate, utilization factor, voltage drop value, and the like are attached to the instance name of the macrocell, the physical information can be grasped without reference to the layout data, and also analysis of the simulation and correction of the layout data can be facilitated. Also, since the placement position designation constraint is generated from the net list including the physical information, the high-quality layout design can be carried out.

### BACKGROUND OF THE INVENTION

1. Field of the Invention

The present invention relates to a layout design of a semiconductor integrated circuit and, more particularly, a net list generating method that makes it easy to execute an analysis while taking account of physical information at a time of timing verification. Also, the present invention relates to a layout designing method that is capable of carrying out a high-quality automatic placement by using a net list containing the physical information.

2. Description of the Related Art

In recent years, higher integration, larger scale, and higher speed of the semiconductor integrated circuit make progress with the tremendous progress of the semiconductor technology. Therefore, the problems in the layout design are to take measures against various problems generated by the physical causes such as a deterioration of the timing convergence caused by an increase in the speed, an increase of signal delay by a power-supply voltage drop or a heat, and the like. The net list generating method and the layout designing approach that take these problems into account have been proposed.

The first prior art as the net list generating method is disclosed in JP-A-2000-222448. The net list generating method in the first prior art will be explained with reference to FIG. 5 hereunder.

In FIG. 5, according to the net list generating method that includes step 501 in which the function description including the gate description is executed, step 502 in which the logic synthesis is executed by reading the function description by means of the automatic logic synthesizing tool while setting that the gate description is left, and step 503 in which the net list in which wiring and cell names are clearly described to show signal names to be left is output, the gate description defined by the function description is left on the net list. Therefore, the man-hour in circuit correction can be reduced.

Also, the second prior art as the layout designing method is disclosed in JP-A-11-259555. The layout designing method in the second prior art will be explained with reference to FIG. 6 hereunder.

In FIG. 6, a net list 602 is generated in a circuit design step 601. Then, a delay simulation of the net list 602 is carried out in a delay simulation step 603, and then it is decided whether the result is good or not. If the decision result poses no problem, the automatic layout is executed in an automatic layout step 604 using the net list 602 as an input.

A net list 605 having information of wiring capacitances that are provided between the logic cells by the automatic layout is output from the automatic layout tool. Then, in a delay calculating step 606, the wiring delay between the logic cells is calculated based on the net list 605 with wiring capacitances as an input file by using the delay calculating tool. Then, a delay information file 607 is output.

Then, the delay simulation is executed in a delay simulation step 608 using the net list 602 and the delay information file 607 as inputs, and then it is decided whether the result is good or not. If the decision result presents no problem, the design in which the wiring delay is considered is ended. Improvement in a precision in delay simulation can be achieved by executing the delay simulation using such net list with wiring capacitances as the input.

However, following problems existed in the above-mentioned prior art. In the net list generating method in the first prior art, because the gate description defined by the function description is left on the net list, the circuit correction can be facilitated. However, because physical information of the layout are not provided, such a problem lies that a man-hour necessary for the circuit correction is increased when the illegal timing is generated based on the result of the delay simulation after the circuit is corrected.

Also, in the layout designing method in the second prior art, because the wiring capacitances are attached to the net list, a precision of delay simulation can be improved. However, because physical information of the layout is inadequately provided, such a problem lies that sometimes the analysis of the delay simulation result becomes difficult and thus a man-hour necessary for the circuit analysis is increased.

Normally, when the illegal timing is present in the result of the delay simulation, the analysis of the illegal timing path is executed based on a timing report. That is, it is analyzed by which one of lack of a cell driving force, placement position, delay variation caused by a voltage drop or a temperature, cross talk, and the like the cause of the illegal timing is affected.

In order to execute these analyses, wiring routes, placement positions, utility factor, etc. must be checked based on the layout data and at the same time a voltage-drop verification report, a thermal distribution verification report, and cross talk verification report must be checked. After the analyses are completed, the correcting method must be studied by looking up the layout data and respective verification reports, like the analysis operation.

For example, the utility factor is checked based on layout data when the correction to add the cell is executed, and a slew value is checked based on the slew report when the wiring is corrected. In this manner, since the physical information not contained in the net list must be checked, a huge amount of man-hour is needed to analyze and correct the result of the delay simulation.

Also, in some cases the coordinate positions of macrocells and the mirror reversion/rotation information are required after the layout design is ended. In this case, the instance names of macrocells are extracted from the net list and simultaneously the coordinate positions of the placement and the mirror reversion/rotation information are extracted from the layout data. Further, the correlation between the extracted instance names and the coordinate positions of macrocells or the mirror reversion/rotation information must be calculated, and thus a huge amount of man-hour is required for the information extraction and the data comparison.

### SUMMARY OF THE INVENTION

It is an object of the present invention to provide a net list generating method that facilitates an analysis and a study while taking account of physical information at a time of timing verification or at a time of design data correction. Also, it is another object of the present invention to provide a layout designing method that facilitates an automatic placement while taking the physical information into consideration.

A net list generating method of the present invention, includes a physical information extracting step of extracting physical information associated with a macrocell after the macrocell is placed in a layout design of a semiconductor integrated circuit; and an instance name converting step of attaching the physical information to an instance name.

In the present invention, the physical information is placement coordinate information of each macrocell.

In the present invention, the physical information is utility factor information of the macrocell calculated every reference range after the macrocell is placed.

In the present invention, the physical information is voltage-drop value information of each macrocell derived from a result of a voltage drop verification after the macrocell is placed.

In the present invention, the physical information is temperature information of each macrocell derived from a result of a temperature verification after the macrocell is placed.

In the present invention, the physical information is slew value information estimated every macrocell.

In the present invention, the physical information is mirror reversion/rotation information of each macrocell.

In the present invention, the physical information is toggle rate information that is propagated to the macrocell by a toggle rate information propagating process that causes the toggle rate information to propagate from the macrocell having the toggle rate information as a start point.

The net list generating method of the present invention further includes a macrocell selecting step of selecting previously the macrocell to which the physical information is attached; and wherein the extracted physical information is attached only to the macrocell that is selected in the macrocell selecting step in the instance name converting step.

The net list generating method of the present invention further includes a physical information selecting step of selecting previously the physical information that is to be extracted in the physical information extracting step.

A layout designing method of the present invention includes a physical information extracting step of extracting the physical information of each macrocell from a net list in which physical information are attached to instance names of the macrocell, in a layout designing method of a semiconductor integrated circuit; a placement position designation constraint converting step of converting the physical information extracted in the physical information extracting step to generate a placement position designation constraint; and an automatic placement step of automatically placing the macrocell by using the placement position designation constraint.

In the present invention, the physical information is placement coordinate information of each macrocell.

In the present invention, the physical information is delay value information of each macrocell.

In the present invention, the physical information is power-supply system information of each macrocell.

According to the above configuration, the physical information of placement coordinate, utilization factor, voltage drop value, temperature, slew value, mirror reversion/rotation, and toggle rate are attached to the instance name of the macrocell. Thus, the physical information can be grasped without reference to the layout data. Therefore, analysis of the delay simulation, correction of the layout data, and formation of the placement position designation constraint can be carried out promptly.

Also, according to the above configuration, the placement position designation constraint is generated from the net list in which the physical information of placement coordinate, delay value, and power-supply system are contained in the instance name of the macrocell, and then the macrocell is automatically placed. Therefore, the high-quality layout data in which the physical information is taken into account can be formed.

According to the present invention, in analyzing the timing error after the timing verification, the identification of the cause and the examination of the correction policy can be carried out without reference to the layout data since the physical information such as the placement coordinate, the slew value, the voltage drop value, and the like are contained in the instance name set forth in the timing report.

Also, according to the present invention, since the placement position designation constraint is formed from the net list including the physical information, the automatic placement can be executed while considering various physical phenomena and the timing convergence can be improved. In addition, since the attached physical information and the attached instance are selected according to the application purpose, any physical information can be taken into account and also the timing analysis can be facilitated.

### BRIEF DESCRIPTION OF THE DRAWINGS

FIG. 1 is a flowchart showing a net list generating method according to Embodiment 1 of the present invention.

FIG. 2 is a flowchart showing a net list generating method according to Embodiment 2 of the present invention.

FIG. 3 is a flowchart showing a net list generating method according to Embodiment 3 of the present invention.

FIG. 4 is a flowchart showing a layout designing method according to Embodiment 4 of the present invention.

FIG. 5 is a flowchart showing a net list generating method in the first prior art.

FIG. 6 is a flowchart showing a net list generating method in the second prior art.

### DESCRIPTION OF THE PREFERRED EMBODIMENTS

### Embodiment 1

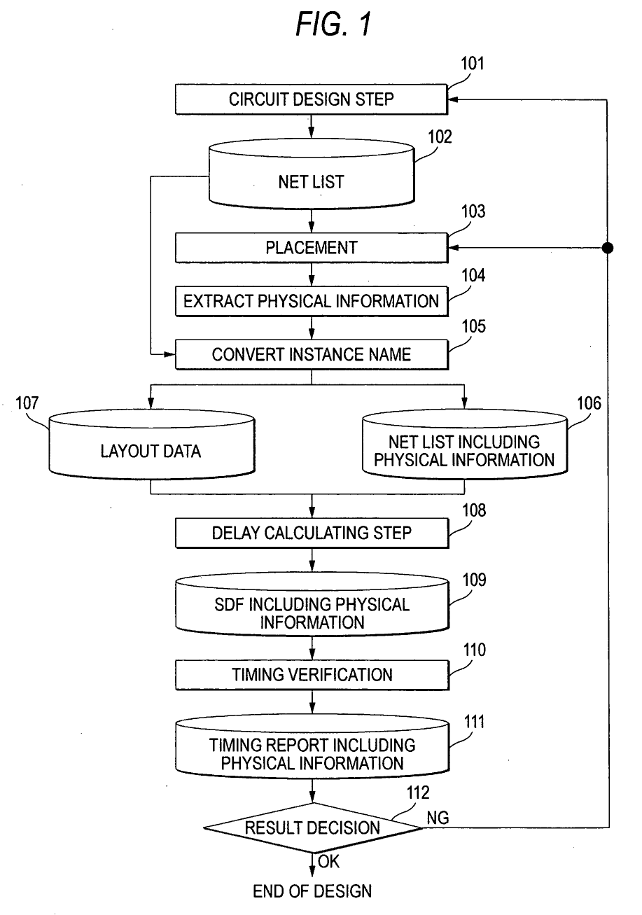

FIG. 1 is a flowchart showing a net list generating method according to Embodiment 1 of the present invention. First, the step of generating a net list 106 including the physical information from a net list 102 will be explained with reference to FIG. 1 hereunder.

Step 101 is a circuit design step by using the logic synthesizing tool, and generates the net list 102. Step 103 is a placement step by using the automatic layout tool, and executes the placement of the macrocell set forth in the net list 102.

Step 104 is a step of extracting the physical information of the macrocell placed in Step 103, and extracts placement coordinate information, voltage-drop value information, temperature information, and utilization factor information of all macrocells set forth in the net list 102.

The placement coordinate information is output from the automatic layout tool placed in step 103, and forms a file in the form in which the instance names of the macrocells and the placement coordinate are correlated with each other.

The voltage-drop value information calculates the voltage-drop values of respective macrocells by the voltage-drop analyzing tool, and forms a file in the form in which the instance names of the macrocells and the voltage-drop values are correlated with each other.

The temperature information outputs temperature information of respective macrocells by the temperature analyzing tool, and forms a file in the form in which the instance names of the macrocells and the temperature information are correlated with each other.

As to the utilization factor information, the overall chip is divided like grids and then the utilization factor in each grid is calculated by the automatic layout tool. Then, a file is formed in the form in which the instance names of the macrocells placed in respective grids and the calculated utilization factor are correlated with each other.

Step 105 is a step of attaching the physical information extracted in step 104 to the instance names set forth in the net list 102, and forms the net list 106 with the physical information. Also, step 105 converts the instance names in the layout data similarly, and forms layout data 107.

For example, when the macrocell having the instance name “INST1” set forth in the net list 102 is placed at coordinates (X,Y)=(1000, 1000) in step 103, the voltage drop value is 10 mV and the temperature is 60° C., and the utility factor of the grid containing this macrocell is 85%, the placement coordinate information of “_X1000Y1000”, the voltage drop information of “_DROP10”, the temperature information of “_THER60”, and the utility factor information of “_UTIL85” are attached to the instance name and then the instance name is converted into the instance name “INST1_X1000Y1000_DROP10_THER60_UTIL85” in step 105.

Then, steps from a delay calculating step 108 of executing the timing verification by using the net list 106 with the physical information to a timing verification result deciding step 112 will be explained hereunder.

Step 108 is a delay calculating step of calculating a cell delay and a wiring delay by the delay calculating tool. Since the net list 106 with the physical information and the layout data 107 are used as the input, the instance name in output SDF 109 including physical information also succeeds to the physical information.

Step 110 is a timing verifying step by the timing verifying tool. Since the SDF 109 including physical information is used as the input, the instance name in output timing report 111 including physical information also succeeds to the physical information.

Step 112 is a timing verification result deciding step. When no problem arises, the design is ended. In contrast, when a certain problem arises, the cause of the timing error is analyzed and then the process goes back to step 101 or step 103.

In analyzing the timing error, the placement coordinate information can be checked from the instance name set forth in the timing report 111 including the physical information. Therefore, it can be decided without check on the layout data 107 whether or not the cause is generated by the inadequate placement position.

Also, in correcting the timing error, the placement position can be specified easily from the placement coordinate information of the connected macrocell when the macrocell serving as the cause of the timing error is to be moved or when the macrocell is to be newly added.

Also, in analyzing the timing error, the voltage drop value can be checked from the instance name set forth in the timing report 111 including the physical information. Therefore, it can be decided without check on the power-supply analysis result report whether or not the cause is generated by the delay variation due to the voltage drop.

Also, in analyzing the timing error, the temperature information can be checked from the instance name set forth in the timing report 111 including the physical information. Therefore, it can be decided without check on the temperature analysis result report whether or not the cause is generated by the delay variation due to the heat generation.

In addition, in correcting the timing error, the utility factor information can be checked from the instance name set forth in the timing report 111 including the physical information. Therefore, when the macrocell serving as the cause of the timing error is to be moved or when the macrocell is to be newly added, it can be specified easily whether or not the macrocell can be placed or in which position the macrocell should be placed.

In the extraction of the physical information of the macrocell in step 104, the physical information useful for the design verification or the layout design can also be extracted in addition to foregoing placement coordinate information, voltage-drop value information, temperature information, and utilization factor information of the macrocell.

As the useful physical information, there is the mirror reversion/rotation information of the macrocell. In this case, the mirror reversion/rotation information of all macrocells set forth in the net list 102 in step 104 are extracted, and then the file in which the instance names of respective macrocells and the mirror reversion/rotation information are correlated with each other is formed.

In step 105, the mirror reversion/rotation information extracted in step 104 are attached to the instance names set forth in the net list 102, and the net list 106 including the physical information is formed. Also, the instance names in the layout data are converted similarly, and the layout data 107 are formed.

For example, when the macrocell having the instance name “INST2” set forth in the net list 102 is placed in step 103 after it is mirror-reversed around an X-axis and rotated by 90 degree, the mirror reversion/rotation information of “_mX_r90” is attached, and then the instance name is converted into the instance name “INST2_mX_r90” in step 105.

The mirror reversion/rotation information is contained in the instance name set forth in the net list 106 including physical information. Therefore, even when the mirror reversion/rotation information of the particular macrocell is needed, desired information can be obtained only by picking out the instance name unless the layout data 107 is check.

Other useful physical information, there are toggle rate information and slew value information of the macrocell. In this case, the toggle rate information and the slew value information of all macrocells set forth in the net list 102 are extracted in step 104.

The toggle rate information is propagated from the macrocell having the toggle rate information as a start point. Then, a file is formed in the form in which the instance names of the macrocells, through which the toggle rate information is propagated, and the toggle rate information are correlated with each other.

Also, the slew value between the macrocells is estimated by the automatic layout tool, and a file is formed in the form in which the instance names of the macrocells and the slew value are correlated with each other.

In step 105, the toggle rate information and the slew value information extracted in step 104 are attached to the instance names set forth in the net list 102, and the net list 106 including the physical information is formed. Also, the instance names in the layout data are converted similarly, and the layout data 107 are formed.

For example, when the toggle rate of the macrocell having the instance name “INST3” set forth in the net list 102 is 20%, the slew value of the input terminal is 2.5 ns, and the slew value of the output terminal is 1.2 ns, the toggle rate information of “_tog02” and the slew value information of “_in25_out12” are attached, and then the instance name is converted into the instance name “INST3_tog02_in25_out12” in step 105.

The toggle rate information and the slew value information are contained in the instance name of the layout data 107. Therefore, the macrocell having the slew value that is close to a threshold value and the macrocell that is operated at a high frequency can be specified only by checking the layout data 107. Also, examination of the policy in avoiding the cross talk error or correcting the placement/routing is facilitated.

### Embodiment 2

According to the net list generating method of Embodiment 1, the physical information can be grasped without reference to plural pieces of data by extracting the physical information of the macrocell and attaching the physical information to the instance names of the macrocell. But there is such a possibility that the instance name becomes correspondingly longer and a data size is increased. In the present embodiment, an increase of data size can be suppressed by imposing a limitation to the macrocell to which the physical information is attached.

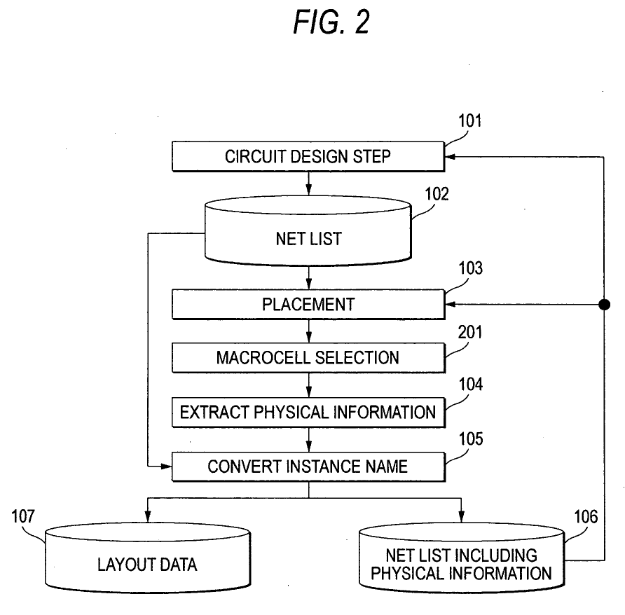

FIG. 2 is a flowchart showing a net list generating method according to Embodiment 2 of the present invention. In FIG. 2, a macrocell selecting step given in step 201 is inserted into the flowchart of the net list generating method according to Embodiment 1 shown in FIG. 1.

In step 201, the macrocell whose physical information is to be considered is selected. In step 104, the physical information of the macrocell selected in step 201 are extracted. In step 105, the physical information extracted in step 104 are attached only to the instance names of the macrocell selected in step 201 and then the net list 106 including the physical information is formed. Also, the instance names in the layout data are converted, and the layout data 107 is formed.

In this manner, since the macrocell of which the attachment of the physical information is required is selected, it can be prevented that the instance names in all macrocells becomes longer and a data size is increased, and thus the timing analysis can be made easy.

### Embodiment 3

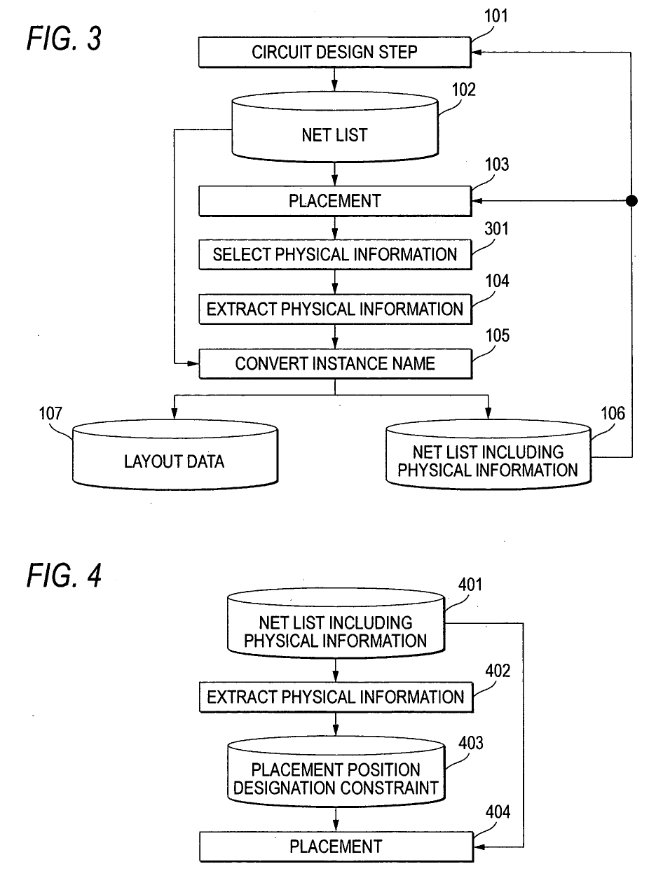

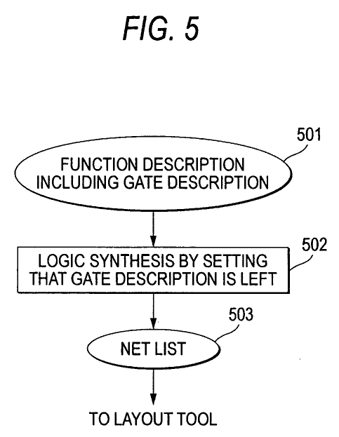

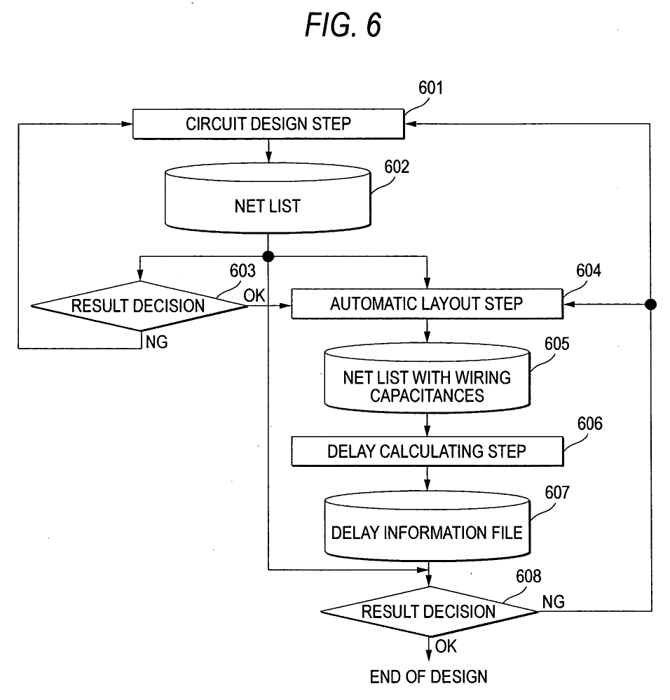

In the present embodiment, an increase of a data size can be suppressed by limiting the physical information that is attached to the macrocell. FIG. 3 is a flowchart showing a net list generating method according to Embodiment 3 of the present invention. In FIG. 3, a physical information selecting step given in step 301 is inserted into the flowchart of the net list generating method according to Embodiment 1 shown in FIG. 1.

In step 301, the physical information that is to be attached to the macrocell is selected. In step 104, only the physical information selected in step 301 are extracted. For example, when the placement coordinate information and the mirror reversion/rotation information are designated in step 301, only the placement coordinate information and the mirror reversion/rotation information are extracted.

In step 105, the physical information extracted in step 104 are attached to the instance names set forth in the net list 102, and then the net list 106 including the physical information is formed. Also, the instance names in the layout data are converted, and the layout data 107 is formed.

In this manner, since the physical information that is to be attached to the macrocell is selected, it can be prevented that the instance names in all macrocells becomes longer and a data size is increased, and thus the timing analysis can be facilitated.

### Embodiment 4

FIG. 4 is a flowchart showing a layout designing method according to Embodiment 4 of the present invention. In the present embodiment, the placement position designation constraint is set by using the net list including the physical information before the placement is executed.

In FIG. 4, a net list 401 including physical information gives a net list to which the physical information such as placement coordinate information, delay value information, or the like, which is needed in the placement, are attached. The placement coordinate to avoid the placement complex location, the placement coordinate allocated to the path whose timing is severe, the delay value, and the like can be set previously.

For example, when the macrocell having the instance name of “INST4” is to be placed on the coordinate (X,Y)=(1000, 1000), “INST4_X1000_Y1000” is set forth in the net list 401 including the physical information.

Step 402 is a step of extracting the physical information from the net list 401 including the physical information, and then forms a placement position designation constraint 403 that the automatic layout tool can recognize.

Step 404 is a placing step of executing the placement of the macrocell set forth in the net list 401 including the physical information by the automatic layout tool, and executes the placement in compliance with the placement position designation constraint 403 formed in step 403.

In this manner, the placement position designation constraint is formed from the net list 401 including the physical information and the automatic layout is carried out. Therefore, the wiring complexity can be avoided and also the timing convergence can be improved.

According to the net list generating method and the layout designing method of the present invention, in analyzing the timing error after the timing verification the identification of the cause and the examination of the correction policy can be carried out without reference to the layout data since the physical information such as the placement coordinate, the slew value, the voltage drop value, and the like are contained in the instance name set forth in the timing report. Also, since the placement position designation constraint is formed from the net list including the physical information, the automatic placement can be executed while considering various physical phenomena and the timing convergence can be improved. In addition, since the attached physical information and the attached instance are selected according to the application purpose, any physical information can be taken into account and also the timing analysis can be facilitated. As a result, the net list generating method and the layout designing method of the present invention is useful as the net list generating method of facilitating the analysis while considering the physical information at a time of timing verification, or the like, and the layout designing method of executing the high-quality automatic placement by using the net list containing the physical information, or the like.

What is claimed is:

1. A net list generating method, comprising:
a physical information extracting step of extracting physical information associated with a macrocell after the macrocell is placed in a layout design of a semiconductor integrated circuit; and
an instance name converting step of attaching the physical information to an instance name.

2. The net list generating method, according to claim 1, wherein the physical information is placement coordinate information of each macrocell.

3. The net list generating method, according to claim 1, wherein the physical information is utility factor information of the macrocell calculated every reference range after the macrocell is placed.

4. The net list generating method, according to claim 1, wherein the physical information is voltage-drop value information of each macrocell derived from a result of a voltage drop verification after the macrocell is placed.

5. The net list generating method, according to claim 1, wherein the physical information is temperature information of each macrocell derived from a result of a temperature verification after the macrocell is placed.

6. The net list generating method, according to claim 1, wherein the physical information is slew value information estimated every macrocell.

7. The net list generating method, according to claim 1, wherein the physical information is mirror reversion/rotation information of each macrocell.

8. The net list generating method, according to claim 1, wherein the physical information is toggle rate information that is propagated to the macrocell by a toggle rate information propagating process that causes the toggle rate information to propagate from the macrocell having the toggle rate information as a start point.

9. The net list generating method, according to claim 1, further comprising:
a macrocell selecting step of selecting previously the macrocell to which the physical information is attached; and
wherein the extracted physical information is attached only to the macrocell that is selected in the macrocell selecting step in the instance name converting step.

10. The net list generating method, according to claim 1, further comprising:
a physical information selecting step of selecting previously the physical information that is to be extracted in the physical information extracting step.

11. A layout designing method, comprising:
a physical information extracting step of extracting the physical information of each macrocell from a net list in which physical information are attached to instance names of the macrocell, in a layout designing method of a semiconductor integrated circuit;
a placement position designation constraint converting step of converting the physical information extracted in the physical information extracting step to generate a placement position designation constraint; and
an automatic placement step of automatically placing the macrocell by using the placement position designation constraint.

12. The layout designing method, according to claim 11, wherein the physical information is placement coordinate information of each macrocell.

13. The layout designing method, according to claim 11, wherein the physical information is delay value information of each macrocell.

14. The layout designing method, according to claim 11, wherein the physical information is power-supply system information of each macrocell.
